(19) United States
(12) Patent Application Publication
(10) Pub. No.: US 2016/0266008 A1
(43) Pub. Date: Sep. 15, 2016

(54) APPARATUS AND METHOD FOR ESTIMATING CRANK ANGLE WHEN ENGINE STOPS

(71) Applicant: Hyundai Motor Company, Seoul (KR)

(72) Inventors: Young Jin PARK, Gwangmyeong-si (KR); Kum Lim CHOI, Seoul (KR); Jeong Mo JANG, Ansan-si (KR); Kyoung Joo KIM, Yongin-si (KR); Jae Wang LEE, Suwon-si (KR); Keun Seok LEE, Hwaseong-si (KR)

(21) Appl. No.: 14/930,187

(22) Filed: Nov. 2, 2015

(30) Foreign Application Priority Data
Mar. 11, 2015 (KR) 10-2015-0033918

(51) Int. Cl. G01M 15/06; G01D 5/14; F02D 41/04

(52) U.S. Cl. CPC G01M 15/06; F02D 41/042; G01D 5/14

(57) ABSTRACT

An apparatus for estimating a crank angle when an engine stops includes a crank sensor generating an output signal indicating a rotational angle of a crankshaft. A resolver generates an output signal indicating a rotor absolute angular position of a motor which is connected to the engine to transmit power. A controller is configured to store output signal data of a crank sensor and output signal data of the resolver until the engine stops, and determines the crank angle based on motor reverse rotation information from the stored crank sensor output signal data and the stored resolver output signal data when the engine stops completely.

### CROSS-REFERENCE TO RELATED APPLICATION

This application claims under 35 U.S.C. §119(a) the benefit of priority to Korean Patent Application No. 10-2015-0033918 filed on Mar. 11, 2015, the entire content of which is incorporated herein by reference.

### TECHNICAL FIELD

The present disclosure relates to an apparatus and a method for estimating a crank angle when an engine stops. More particularly, the present disclosure relates to a method that can accurately estimate a crank angle when an engine stops based on a signal of a crank sensor.

### BACKGROUND

A hybrid vehicle comprises an engine using fossil fuel and a motor using electrical energy as driving sources for traveling in order to reduce the amount of exhaust gas emission and improve fuel efficiency.

FIG. 1 schematically illustrates a hybrid power train of a hybrid vehicle having an engine and a motor for traveling, and an engine clutch and a transmission for power transmission device.

Referring to FIG. 1, a hybrid power train for a hybrid vehicle comprises: an engine 1 and an electric motor 3 in series as driving sources; an engine clutch 2 interposed between the engine 1 and the electric motor 3 so as to transmit or disconnect power; an inverter 5 for driving and controlling the electric motor 3; a transmission 4 which shifts and transmits the power of the engine 1 and the electric motor 3 to a drive shaft; and a hybrid starter and generator (HSG) 7 connected to the engine 1 to transmit the power.

In the related art as described above, the engine clutch 2 selectively transmits or disconnects the power between the engine 1 and the drive motor 3 through locking/unlocking operation using hydraulic pressure.

The conventional hybrid power train further comprises a battery 6, which serves as a power source (electric power source) for the electric motor 3, connected to the electric motor 3 through an inverter 5 to be charged and discharged. The inverter 5 applies a direct current of the battery 6 to the electric motor 3 by converting to a three-phase alternating current for driving the electric motor 3.

As shown in FIG. 1, the HSG 7, which is directly connected to the engine 1 via a belt, is a small capacity motor compared to the electric motor 3. The HSG 7 starts the engine 1 by transmitting its own power to the engine 1 through the belt or generates power by rotational force transmitted from the engine 1, and charges the battery 6 using electrical energy generated during the power generation.

Such a hybrid starter and generator (HSG) assisting an engine output as a driving source for driving a vehicle without an electric motor is well known.

A vehicle having an engine, a hybrid vehicle or a general internal combustion engine vehicle, uses an engine controller (EMS: Engine Management System, ECU: Engine Control Unit) to perform the overall control of the engine such as fuel injection control for driving the engine.

The engine controller collects various information corresponding to control variables from a plurality of sensors. For example, the engine controller receives measurement information, such as a rotational speed of the engine, an intake air quantity, a throttle valve opening, and a pressure of an intake manifold, to determine basic injection quantity of fuel.

Among such control variables, the rotational speed information of the engine is acquired from a signal of a crank sensor (crankshaft angle sensor (CAS), crankshaft position sensor (CPS/CKPS), or the like), and the crank sensor recognizes a top dead center and grasp a position of the piston depending on a rotational angle of the crankshaft, other than acquiring the rotational speed of the engine.

The rotational speed information of the engine obtained from the signal of the crank sensor as described above determines the basic injection quantity of fuel, and the position of the piston determines ignition timing and fuel injection timing of the engine.

In the case of a hybrid vehicle, since the engine is frequently on/off, quick start of the engine is required to ensure the engine re-start or re-acceleration performances of the engine after the engine stops. A technique of reducing the starting time of the engine by determining an engine stop angle (or engine stop position) using the engine controller has been suggested.

However, when determining the engine stop angle to improve engine restart performance, there is a difficulty in accurately determining the engine stop using only the above-mentioned crank sensor, and thus, other hardware may be additionally required.

For example, a crank wheel having a number of gear teeth is integrally mounted to a crankshaft so as to detect a rotational angle of the crankshaft. Thus, it is possible to detect the rotational angle of the crankshaft by mounting the crank wheel having, for example, fifty eight teeth (60−2=58) by removal of two teeth.

Two teeth are removed from sixty teeth to know the absolute angular position of the crankshaft. Accordingly, it is possible to determine a piston position and intake and exhaust strokes of each cylinder based on the rotational angle of the crankshaft obtained through the crank wheel rotating with the crankshaft, and a cam position detected through a cam position sensor.

However, the engine rotates in a reverse direction due to various frictional forces acting on a drive element of the engine during the stop, compressed air in the cylinder, or the like. Since the controller determines the number of teeth of the rotating crank wheel by a signal of the crank sensor when the engine stops, it is not possible to know whether the engine rotates in a normal direction or the reverse rotation, and therefore, it is not possible to accurately determine the crank angle only by the signal of the crank sensor when the engine stops.

The above information disclosed in this Background section is only for enhancement of understanding of the background of the invention, and therefore, it may contain information that does not form the prior art that is already known in this country to a person of ordinary skill in the art.

### SUMMARY OF THE DISCLOSURE The present disclosure has been made in an effort to solve the above-described problems associated with prior art.

An aspect of the present inventive concept provides a method capable of accurately estimating a crank angle while an engine stops using a signal of a crank sensor mounted on a vehicle.

According to an exemplary embodiment of the present inventive concept, an apparatus for estimating a crank angle when an engine stops includes a crank sensor generating an output signal which indicates a rotational angle of a crankshaft. A resolver generates an output signal indicating a rotor absolute angular position of a motor which is connected to an engine to transmit power. A controller is configured to store output signal data of a crank sensor and output signal data of the resolver until the engine stops, and determines the crank angle based on motor reverse rotation information from the stored crank sensor output signal data and the stored resolver output signal data when the engine stops completely.

According to another exemplary embodiment of the present inventive concept, a method for estimating a crank angle of a stopped engine includes receiving, by a controller, an output signal indicating a rotational angle of a crankshaft from a crank sensor. The controller receives an output signal indicating a rotor absolute angular position of a motor that is connected to the engine to transmit power. The controller stores output signal data of the crank sensor t and output signal data of the resolver until the engine stops. The controller determines a crank angle based on motor reverse rotation information from the stored crank sensor output signal data and the stored resolver output signal data when the engine stops completely.

Accordingly, in the apparatus and method for estimating the crank angle when the engine stops completely according to the present disclosure, it is possible to accurately estimate the stopped engine crank angle in which reverse rotation information of the motor is reflected to rotation quantity information, using a resolver output signal of the motor (HSG) connected to the engine in a power-transmittable manner together with the output signal of the crank sensor.

Other aspects and embodiments of the invention are discussed infra.

It is understood that the term “vehicle” or “vehicular” or other similar term as used herein is inclusive of motor vehicles in general such as passenger automobiles including sports utility vehicles SUV, buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles e.g. fuels derived from resources other than petroleum. As referred to herein, a hybrid vehicle is a vehicle that has two or more sources of power, for example both gasoline-powered and electric-powered vehicles.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present invention.

FIG. 1 is a block diagram schematically illustrating a power train of a general hybrid vehicle.

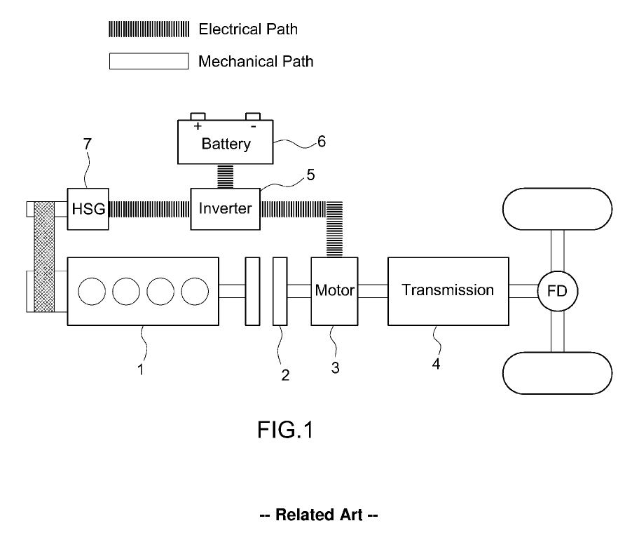

FIG. 2 is a block diagram illustrating an apparatus for estimating a crank angle when an engine stops according to the present disclosure.

FIG. 3 is a flow chart illustrating a method for estimating a crank angle when an engine stops according to the present disclosure.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents, and other embodiments, which may be included within the spirit and scope of the invention as defined by the appended claims.

Hereinafter, embodiments of the present inventive concept will be described in detail so as to be able to be easily performed by a person having ordinary knowledge in the art to which the present invention pertains with reference to the accompanying drawings.

As described above, an engine rotates in a reverse direction due to various frictional forces acting on a driving element of the engine and the compressed air in a cylinder when the engine stops.

In addition, since an engine controller can determine only the number of teeth of a crank wheel from a signal of a crank sensor (crankshaft angle sensor (CAS), crankshaft position sensor (CPS/CKPS), or the like) in a process of stopping the engine, it is not possible to know whether the engine rotates in a normal direction or a reverse direction, and for this reason, it is not possible to determine a crank angle when the engine stops only by the signal of the crank sensor.

In the present disclosure, a sensor such as a resolver is mounted to a motor, which is directly connected to an engine through a belt or the like to transmit power, to detect a motor rotor absolute angular position. Here, the motor includes a hybrid starter and generator (hereinafter, referred to as “HSG”) which is additionally used together with the signal of the crank sensor for starting the engine and electric generation.

Accordingly, it is possible to accurately determine normal/reverse rotation of the motor rotor and a rotor position from the signal of the resolver in the case of the HSG. When matching the absolute position of the engine with the absolute position of HSG, it is possible to determine a position of the engine through the position of the motor rotor of the HSG since the HSG is connected to a crank pulley of the engine through the belt.

However, since the engine controller which receives an input of the crank sensor and a HSG controller (motor control, MCU: Motor Control Unit) which receives an input of the resolver signal transmit and receive data through communication, it is difficult to match the absolute position of the engine and the absolute position of the HSG when there is communication delay or the like.

According to the present disclosure, a method for determining a stop position of an engine stores crank wheel information (crankshaft information) of a crank sensor and motor rotor information from a resolver of an HSG prior before the engine stops and compares the information after the engine stops.

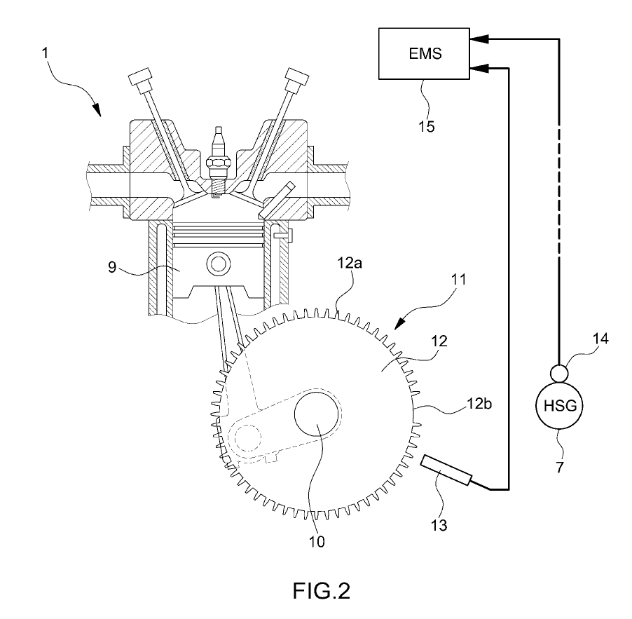

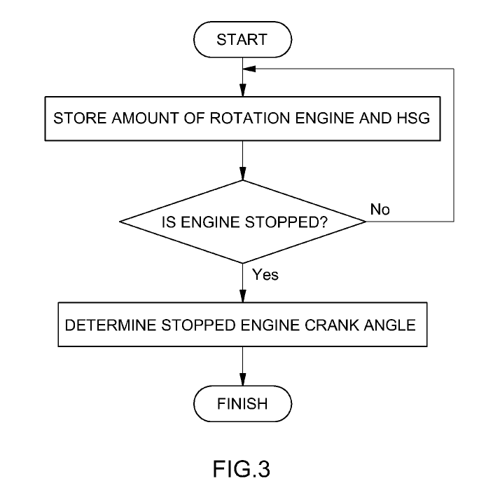

FIG. 2 is a block diagram illustrating an apparatus for estimating a s crank angle when an engine stops according to the present disclosure, and FIG. 3 is a flow chart illustrating a method for estimating a crank angle when an engine stops according to the present disclosure.

As illustrated in FIG. 2, an apparatus 1 for estimating a crank angle when an engine stops according to the present disclosure includes a crank sensor (CAS, CPS, CPKS, or the like) 11 generating an output signal which indicates a rotational angle and a rotational speed (rotational position) of a crankshaft 10. A resolver 14 generates an output signal indicating a rotor absolute angular position of a motor which connected to an engine 1 in a power-transmittable manner, i.e., a HSG 7. A controller 15 is configured to determine the crank angle from the output signals of the crank sensor 11 and the resolver 14 when the engine stops.

The crank sensor 11 is mounted on the vehicle engine 1 in advance, and includes a crank wheel 12 mounted to the crankshaft 10 to integrally rotate with the crankshaft 10, and a sensor 13 that outputs an electric signal according to the rotation of the crank wheel 12.

The crank wheel 12 has a plurality of teeth 12a and missing teeth 12b of one or two teeth for displaying an absolute position of the crankshaft 10 and a top dead center position of a piston 9.

When the crank wheel 12 rotates with the crankshaft 10 while the crank sensor 11 is on, an electrical signal of pulse form is outputted from the sensor 13. Then, the controller 15 receives an input of the electrical signal to determine rotation quantity of the engine 1 (the rotational angle and the rotational position), that is, the rotational angle and the rotational position of the crankshaft 10. In addition, the controller 15 determines the rotational speed of the crankshaft 10 (rotational speed of the engine).

FIG. 2 describes a situation in which the crank wheel 12 having two teeth missing. The controller 15 determines the rotational quantity of the engine 1 by checking the number of teeth 12a after passing a portion in which the two missing teeth 12b, that is, a missing teeth (12b) portion when the crank wheel 12 rotates according to the electrical signal in the form of pulses from the sensor 13.

In the present disclosure, the controller 15 may determine that the crank shaft 10 rotates whenever a signal indicating the missing teeth 12b in the crank wheel 12 is input while the engine is on, and reset crankshaft rotational angle information after each rotation, that is, reset the rotational quantity information of the engine 1 to zero after each rotation, by determining the one rotation of the crankshaft 10 and the crank wheel 12 according to the signal indicating the missing teeth 12b.

That is, when the signal indicating the missing teeth 12b from the sensor 13 is input, the controller 15 counts the number of teeth 12a of the crank wheel 12 from a position of the missing teeth 12b and stores the counted number of teeth 12a. When the signal indicating the missing teeth 12b is inputted again, the controller 15 resets the number of teeth 12a to zero.

Therefore, each time the crankshaft 10 and the crank wheel 12 rotate once when the engine is on, the number of the teeth 12a is counted and stored from the position of the missing teeth 12b. When the signal of the missing teeth 12b is input, the number of the teeth 12a is reset to zero.

Such processes are executed continuously until the engine 1 stops.

The data stored by counting the number of teeth is reset as described above, and the rotational angle and the rotational position (the rotational angle and the rotational position of the crankshaft) of the engine 1 are determined from the number of teeth 12a of the engine 1 counted from the position of the missing teeth 12b.

The controller 15 determines whether the engine 1 attempts to stop when a rotational speed (rpm) of the engine falls below a set speed (for example, 100 rpm, and thereafter, the controller determines whether the reverse rotation of the HSG 7 occurs from the output signal of the resolver 14.

At this time, the controller 15 stores output signal data of the resolver 14, from the time detecting the reverse rotation of the HSG 7 starts until the engine is off, and resets the output signal data of the resolver 14 (e.g., to zero) when the engine 1 starts again.

In addition, the controller 15 determines whether the engine 1 and the HSG 7 are completely off based on the output signal of the crank sensor 11 and the signal of the resolver 14. When the rotational speed of the engine 1 and the rotational speed of the HSG 7 maintain 0 rpm during a set time based on the crank sensor signal and the resolver signal, the controller 15 determines that the engine is off.

After it is determined that the engine is off, the controller 15 determines the crank angle using the stored information, that is, the output signal data of the crank sensor 11 and the output signal data of the resolver 14.

Since the output signal data of the crank sensor 11 is stored by counting the number of teeth 12a from the position of the missing teeth 12b of the crank wheel 12, information on the rotational quantity of the engine 1 has only the absolute value of a rotational distance without information on positive/reverse rotation.

For example, after detecting missing teeth 12b before the engine 1 stops, if the engine 1 stops after rotating by 60° in a normal direction and rotating by 30° in a reverse direction with a crank wheel having 58 teeth and two missing teeth, the total of 15 teeth are counted in which 10 teeth are counted during rotation in the normal direction and 5 teeth are counted during rotation in the reverse rotation since the teeth has an interval of 6° therebetween.

Thus, since the output signal data of the crank sensor 11, that is, 15 teeth counted is not separated between the normal and reverse rotation, when the engine is off after the reverse rotation, 15 teeth do not provide stopped engine crank angle information, and therefore, it is not possible to determine the stopped engine crank angle only by the data of the output signal of the stored crank sensor 11.

Thus, the controller 15 additionally uses the stored output signal data of the resolver 14, and the crank angle is determined when the engine is off by additional utilizing the information on the reverse rotation of the HSG 7 since the output signal data of the resolver 14 includes all the information on the reverse rotation and the normal rotation of s motor rotor.

According to the above example, since the engine 1 stops after the reverse rotation by 30°, the stored output signal data of the resolver 14 includes the reverse rotation information of 30°, and the controller 1 determines the stopped engine crank angle based on the reverse rotation information of 30° from the rotational angle information detected and stored by the crank sensor 11.

For example, the reverse rotation information of 30° means that the engine rotates in the reverse direction as much as five teeth corresponding to 30° in the teeth information stored as 15, and thus, it is possible to determine the stopped engine crank angle from the information of 30° obtained by subtracting 30° rotational position in the reverse direction from the 60° rotational position in the normal direction.

According to the present disclosure, the controller 15 can determine the stopped engine crank angle, on the basis of the resolver detection information when the engine stops, in particular, the reverse rotation information of HSG 7 acquired by the resolver 14, along with the crank sensor detection information until the engine 1 completely stops.

That is, the controller 15 can determine the stopped engine crank angle from the number of subtracted teeth, by subtracting the reverse rotation information included in the data of the resolver output signal, i.e., the number of teeth corresponding to the reverse rotational quantity, from the number of teeth of the crank wheel of the crank sensor 11 stored by counting up to the complete stop of the engine 1.

The stopped engine crank angle may be determined based on the subtracted angle, by subtracting the HSG reverse rotational angle of the data of the stored resolver output signal from the rotational angle of the engine 1 corresponding to the number of teeth stored by counting.

In the present disclosure, the controller 15 may be a normal engine controller (EMS/ECU) configured to receive the input signal of the crank sensor 11 and configured to directly receive the output signal data of the resolver 14 installed in the HSG 7.

Although the controller 15 may be configured to directly receive the input data of the output signal from the resolver 14, the controller may receive the output signal of the resolver 14 through a motor controller (MCU) since the output signal of the resolver 14 is input to another HSG controller controlling the HSG 7, i.e., MCU.

In this case, although the data of the resolver output signal transmitted to the controller 15, i.e., the engine controller from the motor control may be the data of the resolver output signal that includes the reverse rotation information, only inverse rotation information of the resolver output signal data may be extracted and transferred to the engine controller via controller area network (CAN) communication.

The reverse rotation information and the inverse rotational information may include inverse rotational angular information representing the reverse rotation quantity of the HSG 7, while including the information that allows the engine controller to recognize the reverse rotation of the HSG 7 (which means the reverse rotation of the engine).

Further, when inputting the resolver output signal to the motor controller rather than the engine controller, if the engine controller determines that the engine rotational speed (rpm) falls below a reference speed and the engine stops as described above, the engine controller sends the determination result to the motor controller to cause the motor control to determine the reverse rotation of the HSG from a resolver output signal and to store data of the resolver output signal.

Additionally, since the engine controller needs to recognize that a rotational speed of HSG is 0 rpm to determine whether the engine is completely off, the motor controller can be set to notify the stopped state of the HSG to the engine controller when recognizing that the rotational speed of HSG is 0 rpm from the output signal of the resolver.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for estimating a crank angle when an engine stops, the apparatus comprising:
a crank sensor generating an output signal which indicates a rotational angle of a crankshaft;
a resolver generating an output signal which indicates a rotor absolute angular position of a motor that is connected to the engine to transmit power; and
a controller configured to store output signal data of the crank sensor and output signal data of the resolver until the engine stops and to determine the crank angle based on motor reverse rotational angle information from the stored crank sensor output signal data and the stored resolver output signal data when the engine stops completely.

2. The apparatus of claim 1, wherein the controller determines whether the crankshaft rotates once based on the output signal of the crank sensor to reset the output signal data of the crank sensor each time the crankshaft rotates once.

3. The apparatus of claim 2, wherein when the crank sensor sends a signal indicating missing teeth of a crank wheel which is integrally connected to the crankshaft, the controller counts the number of teeth on the crank wheel from the missing teeth and stores the number of counted teeth, and
the controller recounts, after resetting the number of teeth to zero each time the crank sensor sends the signal indicating the missing teeth, the number of teeth on the crank wheel from the missing teeth.

4. The apparatus of claim 3, wherein the controller subtracts the number of teeth corresponding to the motor reverse rotational angle information from the number of teeth of the crank wheel and determines the crank angle from the subtracted number of teeth.

5. The apparatus of claim 3, wherein the controller subtracts a motor reverse rotational angle, which is obtained from the motor reverse rotational angle information, from the rotational angle of the crankshaft from the stored crank sensor output signal data to determine the crank angle from the subtracted angle.

6. The apparatus of claim 1, wherein the controller determines that the engine tries to stop when a rotational speed of the engine is less than a reference speed and determines whether the motor rotates in a reverse direction based on the resolver output signal to store the resolver output signal data from when the reverse rotation of the motor is determined until when the engine stops completely.

7. The apparatus of claim 6, wherein the controller resets the stored resolver output signal data when the engine starts.

8. A method for estimating a crank angle when an engine stops, the method comprising:
receiving, by a controller, an output signal indicating a rotational angle of a crankshaft from a crank sensor;
receiving, by the controller, an output signal indicating a rotor absolute angular position of a motor which is connected to the engine in a power-transmittable manner from a resolver;
storing, by the controller, output signal data of the crank sensor until the engine stops and output signal data of the resolver; and
determining, by the controller, the crank angle based on motor reverse rotational angle information from the stored crank sensor output signal data and the stored resolver output signal data when the engine stops completely.

9. The method of claim 8, further comprising:
determining that the crankshaft rotates once based on the output signal of the crank sensor to reset the output signal data of the crank sensor each time the crankshaft rotates once.

10. The method of claim 9, further comprising:
counting, when the crank sensor sends a signal indicating missing teeth of a crank wheel which is integrally connected to the crankshaft, the number of teeth on the crank wheel from the missing teeth and storing the number of counted teeth, and
recounting, after the number of the stored teeth is reset to zero each time the signal indicating the missing teeth is input, the number of teeth on the crank wheel from the missing teeth.

11. The method of claim 10, further comprising:
subtracting the number of teeth corresponding to the motor reverse rotational angle information from the number of teeth of the crank wheel to determine the crank angle from the subtracted number of teeth when the engine stops.

12. The method of claim 10, further comprising:
subtracting a motor reverse rotational angle, which is obtained from the motor reverse rotational angle information, from the rotational angle of the crankshaft from the stored crank sensor output signal data to determine crank angle from the subtracted angle when the engine stops.

13. The method of claim 8, further comprising:
determining whether the motor rotates in a reverse direction based on the resolver output signal by determining that the engine tries to stop when a rotational speed of the engine is less than a reference speed, and
storing the resolver output signal data from when the reverse rotation of the motor is determined until when the engine stops completely.

14. The method of claim 13, further comprising:
resetting the stored resolver output signal data when the engine starts.
